(19) United States
(12) Patent Application Publication
(10) Pub. No.: US 2026/0051004 A1
(43) Pub. Date: Feb. 19, 2026

(54) SIMPLE SEARCH METHOD USING DRAGGED ADDRESS

(71) Applicant: Ki Young KIM, Gwangmyeong-si (KR)

(72) Inventor: Ki Young KIM, Gwangmyeong-si (KR)

(21) Appl. No.: 19/293,339

(22) Filed: Aug. 7, 2025

(30) Foreign Application Priority Data
Aug. 14, 2024 (KR) 10-2024-0108795

(51) Int. Cl. G06Q 50/16; G06F 3/0482; G06F 3/0486; G06Q 30/0601

(52) U.S. Cl. CPC G06Q 50/16; G06F 3/0482; G06F 3/0486; G06Q 30/0625

(57) ABSTRACT

An easy search method using a dragged address is proposed, and the method includes in a case of receiving input of a selection on a specific menu from among context menus after a mouse drag of a user, i) automatically requesting a web server linked to the specific menu to search for the address specified by the drag, and ii) automatically displaying a web document received as a response to the automatic request in a new tab or new window of a browser.

### CROSS REFERENCE TO RELATED APPLICATION

The present application claims priority to Korean Patent Application No. 10-2024-0108795, filed Aug. 14, 2024, the entire contents of which are incorporated herein for all purposes by this reference.

### BACKGROUND OF THE INVENTION

### Field of the Invention

The present disclosure relates to a simple search method capable of easily searching PropTech sites, etc., and displaying results thereof.

### Description of the Related Art

PropTech services such as Asil or Hogangnono provide real estate information such as property offering information, sales information, and actual transaction price information for land, houses, buildings, or apartments.

Typically, a user may visit a corresponding site and acquire online real estate information he or she desires after performing a search using a building name, land lot number or address, etc., or after selecting information in question from a list displayed as search results.

Meanwhile, while reading a blog, article, report, or website, the user may desire to check the information of a PropTech site at a specific address (e.g., the information of a corresponding address on an Asil website).

In such a case, the user may acquire the desired information through a process of copying the corresponding address from the blog, article, report, or website, opening the PropTech site, and pasting the copied address.

When such a process is described in more detail, the operations required are roughly as follows: [Select an address by a mouse drag-Right click a mouse-Copy by selecting a “Copy” menu→Open a PropTech site (→Click for menu movement in a case where moving to a specific menu is required)→Left click the mouse on an input window for pasting the address→Paste→Return or execute a search].

As described above, it is a very cumbersome problem for the user as it requires a large number of operations. Furthermore, in a case where a desired Internet site is not bookmarked, there is an added hassle of having to enter a corresponding website address and the like to open a PropTech site.

### Documents of Related Art

(Patent Document 1) Korea Patent Application Publication No. 10-2002-0035697, published on May 15, 2002

### SUMMARY OF THE INVENTION

An objective of the present disclosure is to provide a simple search method using a dragged address, enabling more convenient acquisition of desired address-based information from a PropTech site, etc.

According to one aspect of the present disclosure, there is provided a simple search method using a dragged address as the method being performed in a computer, the method including: in a case of receiving input of a selection on a specific menu from among context menus after a mouse drag of a user, i) automatically requesting a web server linked to the specific menu to search for the address specified by the drag; and ii) automatically displaying a web document received as a response to the automatic request in a new tab or new window of a browser.

In the simple search method using the dragged address, the web server linked to the specific menu may be a server of a PropTech site.

In the simple search method using the dragged address, the web document received as the response may include map information centered on the address.

In the simple search method using the dragged address, the web document received as the response may include real estate information of the address.

In the simple search method using the dragged address, the method may further include displaying the context menus including the specific menu in a case where a right button of the user's mouse is clicked.

In the simple search method using the dragged address, the method may be executed by an extension program loaded in the browser.

In the simple search method using the dragged address, the extension program may include code that automatically assembles a URL used to automatically request the web server linked to the specific menu to perform a search by the address.

In the simple search method using the dragged address, the extension program may further include: code for creating a context menu; and code for specifying a title of the context menu.

According to the simple search method using the dragged address of the present disclosure, there is an advantage in that desired address-based information may be acquired more conveniently from a PropTech site, etc.

According to the simple search method using the dragged address of the present disclosure, there is an advantage in that a user's operation procedure is greatly reduced, thereby allowing convenient acquisition of address-based information.

### BRIEF DESCRIPTION OF THE DRAWINGS

FIG. 1 is a system block diagram illustrating a computer, network, and server on which a simple search method using a dragged address according to one exemplary embodiment of the present disclosure is performed.

FIG. 2 is a flowchart illustrating an example of performing the simple search method using the dragged address according to one exemplary embodiment of the present disclosure.

FIG. 3 is a view illustrating an example of a manifest file in an extension program loaded into a browser to implement the simple search method using the dragged address according to one exemplary embodiment of the present disclosure.

FIG. 4 is a view illustrating an example of a background file in the extension program loaded into the browser to implement the simple search method using the dragged address according to one exemplary embodiment of the present disclosure.

### DETAILED DESCRIPTION OF THE INVENTION

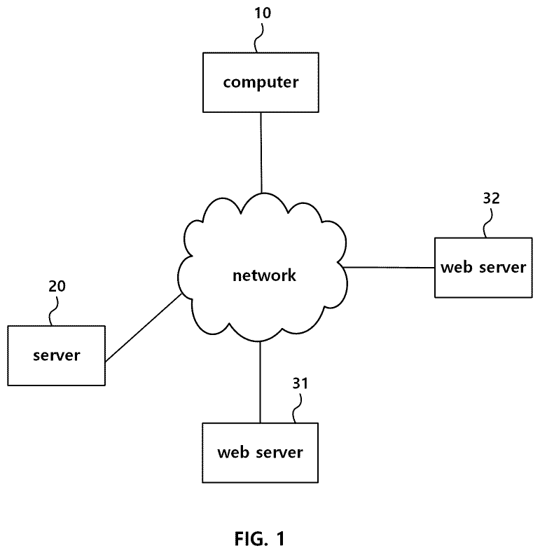

FIG. 1 is a system block diagram illustrating a computer, network, and server on which a simple search method using a dragged address according to one exemplary embodiment of the present disclosure is performed.

A computer 10 is a device used by a user and may be a PC, a tablet computer, a smartphone, or the like.

The simple search method using the dragged address according to one exemplary embodiment of the present disclosure is mainly executed on the user's computer 10. In order to execute the simple search method using the dragged address according to one exemplary embodiment of the present disclosure, the computer 10 may be a computer in which an extension program for the embodiment of the present disclosure is loaded (registered) in a browser, or for the embodiment of the present disclosure, a registry file of a Windows system is modified or code is added.

The computer 10 is provided with a processor, a storage device, a display device, and a mouse, and may receive a drag input through a mouse operation from the user. The computer 10 displays context menus in a case where a right button of the user's mouse is clicked, and when the user selects a specific menu from among the context menus with the mouse, the computer 10 receives input of the selection on the specific menu from among the context menus and automatically requests a search using an address specified by the mouse drag to web servers 31 and 32 linked to the specific menu.

In addition, the computer 10 opens a new tab or new window of the browser and automatically displays web documents received from the web servers 31 and 32 in response to the automatic request in the new tab or new window of the browser.

A server 20 is a device for providing a corresponding source when the user reads a blog, article, report, auction site, public auction site, email, or document by using the computer 10, and preferably, such a sever may also be a web server.

Each of the web servers 31 and 32 is a server linked to a specific menu among context menus, and preferably, is a sever of a PropTech site. Such web servers may be servers providing PropTech services such as Asil, Hogangnono, Sonpumwang, Disco, or Zillow. The web servers 31 and 32 may operate in close connection with devices or servers that perform backend functions not shown herein.

Each of the web servers 31 and 32 receives an HTTP request including a search address (i.e., an address specified by a mouse drag) in an URL from the computer 10, and each of the web servers 31 and 32 composes the web documents as a response to the HTTP request and transmits it to the computer 10.

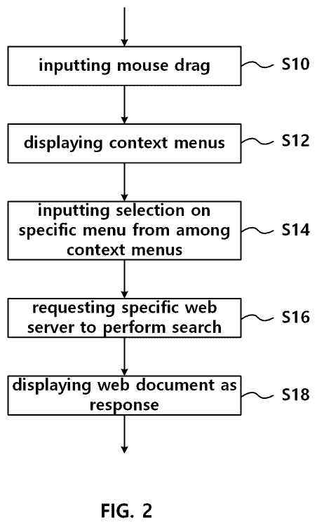

FIG. 2 is a flowchart illustrating an example of performing the simple search method using the dragged address according to one exemplary embodiment of the present disclosure.

An situation may be assumed that a user is using a computer 10 to read a blog, an article, a report, an auction site, a public auction site, an email, or a document. The blog, article, report, auction site, public auction site, email, or document may use a website and the like, so as to display something provided by the server 20, or display something that the user's computer 10 has on its own.

At this time, in a case where the user desires to check PropTech site information, etc. for an address included in the blog, article, report, auction site, public auction site, email, document, or the like, the user uses a mouse to drag the corresponding address (this address should be in text format, not an image). In step S10, the computer 10 receives input of a mouse drag by a mouse operation from the user.

In addition, in step S12, the computer 10 displays context menus in a case where the right button of the user's mouse is clicked, and the context menus may include a basic menu and an extended menu. The context menus include specific menu(s) that represent the address search for a PropTech site. For example, the specific menu(s) may be menu(s) displayed as something like “View on Asil” or “View on Zillow”.

A web server linked to a specific menu may be a server of the PropTech site, and such a web server may be a server providing the PropTech services such as Asil, Hogangnono, Sonpumwang, Disco, or Zillow.

In addition, when the user selects a specific menu from among the context menus with the mouse, the computer 10 receives input of the selection on the specific menu from among the context menus in step S14. In a case where the computer 10 receives the input of the selection on the specific menu from among the context menus after the user's mouse drag, the computer 10 automatically requests the web servers 31 and 32 linked to the specific menu to search for an address specified by the mouse drag in step S16. Such an automatic request to each of the web servers 31 and 32 may be a HTTP Get method including the search address in an URL (i.e., the address specified by the mouse drag).

A corresponding web server composes a web document as a response to the HTTP request and transmits it to the computer 10. In step S18, the computer 10 opens a new tab or a window of a browser and automatically displays the web document received from the web server as the response to the automatic request in the new tab or window of the browser. The web document received as the response includes real estate information for the corresponding address (i.e., the address specified by the drag). In addition, the web document received as the response may include online map information centered on the corresponding address (the address specified by the drag). The online map information may be centered on the corresponding address. The real estate at the corresponding address may be indicated by an icon, etc.

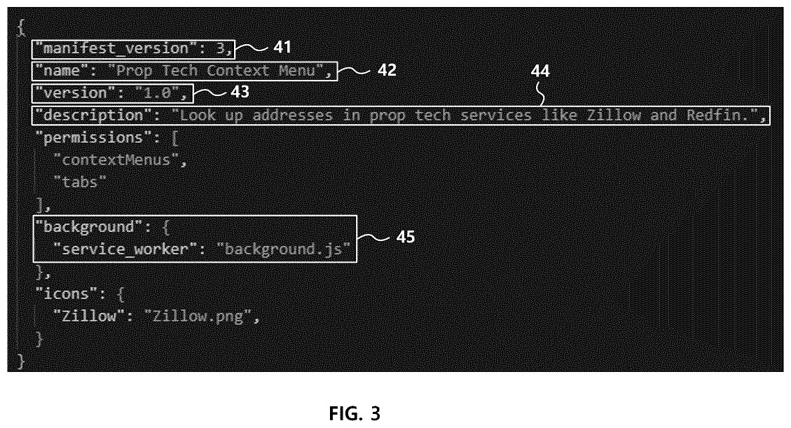

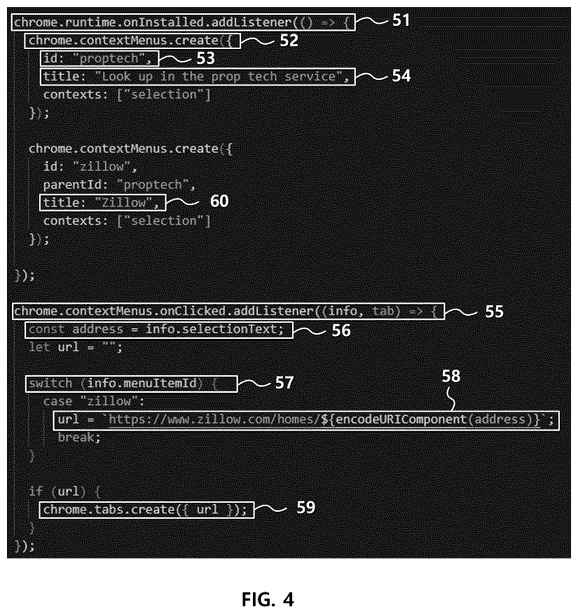

FIG. 3 is a view illustrating an example of a manifest file in an extension program loaded into a browser to implement the simple search method using the dragged address according to one exemplary embodiment of the present disclosure. FIG. 4 is a view illustrating an example of a background file in the extension program loaded into the browser to implement the simple search method using the dragged address according to one exemplary embodiment of the present disclosure.

The simple search method using the dragged address according to one exemplary embodiment of the present disclosure may be executed by the extension program loaded into the browser.

Code 41 indicates the version of a manifest file being used. Code 42 determines the name of an extension, and may be displayed on an extension page in a web store and a browser. Code 43 indicates the version of the extension, and code 44 provides a brief description of the extension. Such description may be displayed on the extension page in the web store and the browser. Code 45 indicates that a file name “background.js” is used for a background file.

Code 51 checks whether an extension function is installed, and code 52 creates a context menu. An extension program includes the code that creates the context menu.

Code 53 gives an action an ID of “PropTech”, and code 54 sets the name of a context menu of this action to “Look up in the PropTech service” and makes it appear in the context menu.

Code 60 specifies the title of the context menu, e.g., “Zillow”, and accordingly, the context menu may display the menu “Zillow” under a menu “Look up in the PropTech service”. The extension program includes code that specifies the title of the context menu.

Code 55 specifies information appearing when clicked as “info”, and specifies information appearing on a tab at the moment of a click as “tab”. Information on a dragged address is retrieved by code 56 as soon as a context menu is clicked, and is used as address information to be checked.

Code 57 transmits information stored in the “info” to the clicked context menu, and code 58 is code for composing an URL used when making an automatic request to a web server. The extension program automatically assembles the URL used to automatically request the web server linked to the specific menu to perform a search by the address, and to this end, includes code such as code 58 as an example. Code 59 causes a final URL to be opened in a new tab.

What is claimed is:

1. A simple search method using a dragged address as the method being performed in a computer, the method comprising:
in a case of receiving input of a selection on a specific menu from among context menus after a mouse drag of a user,
i) automatically requesting a web server linked to the specific menu to search for the address specified by the drag; and
ii) automatically displaying a web document received as a response to the automatic request in a new tab or new window of a browser.

2. The method of claim 1, wherein the web server linked to the specific menu is a server of a PropTech site.

3. The method of claim 1, wherein the web document received as the response comprises map information centered on the address.

4. The method of claim 1, wherein the web document received as the response comprises real estate information of the address.

5. The method of claim 1, further comprising:
displaying the context menus comprising the specific menu in a case where a right button of the user's mouse is clicked.

6. The method of claim 5, wherein the method is executed by an extension program loaded in the browser.

7. The method of claim 6, wherein the extension program comprises code that automatically assembles a URL used to automatically request the web server linked to the specific menu to perform a search by the address.

8. The method of claim 7, wherein the extension program further comprises:
code for creating a context menu; and
code for specifying a title of the context menu.
